(19) United States
(12) Patent Application Publication
(10) Pub. No.: US 2026/0360781 A1
(43) Pub. Date: Nov. 12, 2026

(54) CONTROL METHOD FOR WATER ELECTROLYSIS SYSTEM

(71) Applicant: HONDA MOTOR CO., LTD., TOKYO (JP)

(72) Inventor: Keizo IWAMA, WAKO-SHI (JP)

(21) Appl. No.: 19/665,631

(22) Filed: May 1, 2026

(30) Foreign Application Priority Data
May 12, 2025 (JP) 2025-079880

(51) Int. Cl. H01M 8/04746; H01M 8/0656

(52) U.S. Cl. CPC H01M 8/04753; H01M 8/0656

(57) ABSTRACT

A control method for a water electrolysis system comprises a water electrolysis step, a stopping step of causing the water electrolysis of a water electrolysis stack to stop, after the stopping step, a pressure adjustment step that is capable of setting a pressure of the hydrogen gas inside a first gas-liquid separator to a pressure that is lower than the pressure of the oxygen gas inside a second gas-liquid separator, after the pressure adjustment step, a water recovery step in which, using a differential pressure between the pressure of the hydrogen gas inside the first gas-liquid separator and the pressure of the oxygen gas inside the secondgas-liquid separator, water that is stored inside the second gas-liquid separator is returned via a water recovery path to the first gas-liquid separator.

### CROSS-REFERENCE TO RELATED APPLICATIONS

This application is based upon and claims the benefit of priority from Japanese Patent Application No. 2025-079880 filed on May 12, 2025, the contents of which are incorporated herein by reference.

### BACKGROUND OF THE INVENTION

### FIELD OF THE INVENTION

The present disclosure relates to a control method for a water electrolysis system.

### DESCRIPTION OF THE RELATED ART

In recent years, in order to make it possible for more people to be capable of relying thereon at an affordable cost, and to ensure access to sustainable and advanced energy, research and development have been conducted in relation to a water electrolysis system that contributes to energy efficiency.

For example, in JP 7460718 B1, there is disclosed a water electrolysis system equipped with a water electrolysis stack that electrolyzes water and thereby generates a hydrogen gas and an oxygen gas.

### SUMMARY OF THE INVENTION

There is a long awaited need for a more satisfactory control method for a water electrolysis system.

The present invention has the object of solving the aforementioned problem.

An aspect of the present disclosure is characterized by a control method for a water electrolysis system, comprising a water electrolysis step in which, by water that is stored in a first gas-liquid separator being supplied to a water electrolysis stack via a water supply path and an electrical current being supplied to the water electrolysis stack, a hydrogen gas and an oxygen gas are generated, wherein the hydrogen gas isguided to the first gas-liquid separator and the oxygen gas is guided to a second gas-liquid separator, a stopping step of causing water electrolysis of the water electrolysis stack to stop, after the stopping step, a pressure adjustment step that is capable of setting a pressure of the hydrogen gas inside the first gas-liquid separator to a pressure that is lower than apressure of the oxygen gas inside the second gas-liquid separator; and after the pressure adjustment step, a water recovery step in which, using a differential pressure between the pressure of the hydrogen gas inside the first gas-liquid separator and the pressure of the oxygen gas inside the secondgas-liquid separator, water that is stored in the second gas-liquid separator is returned via a water recovery path to the first gas-liquid separator.

According to the present disclosure, it is possible to obtain a more satisfactory control method for a water electrolysis system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of an energy system equipped with a water electrolysis system;

FIG. 2 is a schematic diagram of a water electrolysis cell;

FIG. 3 is a block diagram of a control device;

FIG. 4 is a flowchart for describing a control method for the water electrolysis system;

FIG. 5 is an explanatory diagram of the control method for the water electrolysis system;

FIG. 6 is an explanatory diagram of the control method for the water electrolysis system;

FIG. 7 is an explanatory diagram of the control method for the water electrolysis system;

FIG. 8 is an explanatory diagram of the control method for the water electrolysis system;

FIG. 9 is an explanatory diagram of the control method for the water electrolysis system;

FIG. 10 is an explanatory diagram of the control method for the water electrolysis system;

FIG. 11A is a graph showing changes in pressure of hydrogen gas inside a first gas-liquid separator and changes in pressure of oxygen gas inside a second gas-liquid separator in the water electrolysis system shown in FIGS. 1 and 11B, is a graph showing changes in pressure of hydrogen gas inside a hydrogen gas tank and changes in pressure of oxygen gas inside an oxygen gas tank in the water electrolysis system shown in FIG. 1;

FIG. 12 is a schematic diagram of an energy system equipped with a water electrolysis system according to a first exemplary modification;

FIG. 13A is a graph showing changes in pressure of hydrogen gas inside a first gas-liquid separator and changes in pressure of oxygen gas inside a second gas-liquid separator in the water electrolysis system shown in FIGS. 12, and 13B, is a graph showing changes in pressure of hydrogen gas inside a hydrogen gas tank and changes in pressure of oxygen gas inside an oxygen gas tank in the water electrolysis system shown in FIG. 12;

FIG. 14 is a schematic diagram of an energy system equipped with a water electrolysis system according to a second exemplary modification;

FIG. 15A is a graph showing changes in pressure of hydrogen gas inside a first gas-liquid separator and changes in pressure of oxygen gas inside a second gas-liquid separator in the water electrolysis system shown in FIGS. 14, and 15B, is a graph showing changes in pressure of hydrogen gas inside a first hydrogen gas tank and a second hydrogen gas tank, and changes in pressure of oxygen gas inside an oxygen gas tank in the water electrolysis system shown in FIG. 14;

FIG. 16 is a schematic diagram of an energy system equipped with a water electrolysis system according to a third exemplary modification; and

FIG. 17A is a graph showing changes in pressure of hydrogen gas inside a first gas-liquid separator and changes in pressure of oxygen gas inside a second gas-liquid separator in the water electrolysis system shown in FIGS. 16, and 17B, is a graph showing changes in pressure of hydrogen gas inside a first hydrogen gas tank and a second hydrogen gas tank, and changes in pressure of oxygen gas inside an oxygen gas tank in the water electrolysis system shown in FIG. 16.

### DETAILED DESCRIPTION OF THE INVENTION

The water electrolysis system is equipped with a water electrolysis stack and a first gas-liquid separator and a second gas-liquid separator that are capable of storing water. The water that is stored in the first gas-liquid separator is supplied to the water electrolysis stack. The hydrogen gas (containing water) that is generated in the water electrolysis stack is guided to the first gas-liquid separator, and gas-liquid separation is carried out thereon. The oxygen gas (containing water) that is generated in the water electrolysis stack is guided to the second gas-liquid separator, and gas-liquid separation is carried out thereon. It is necessary for the water that is stored in the second gas-liquid separator to be returned via the water recovery path to the first gas-liquid separator.

In such a water electrolysis system, in the case that a pump is provided that returns the water that is stored in the second gas-liquid separator to the first gas-liquid separator, the pump consumes electrical power, which thereby reduces the energy efficiency of the water electrolysis system. The present disclosure is capable of providing a control method for a water electrolysis system, which, without providing such a pump, is capable of returning the water that is stored in the second gas-liquid separator to the first gas-liquid separator, and is capable of suppressing a decrease in energy efficiency.

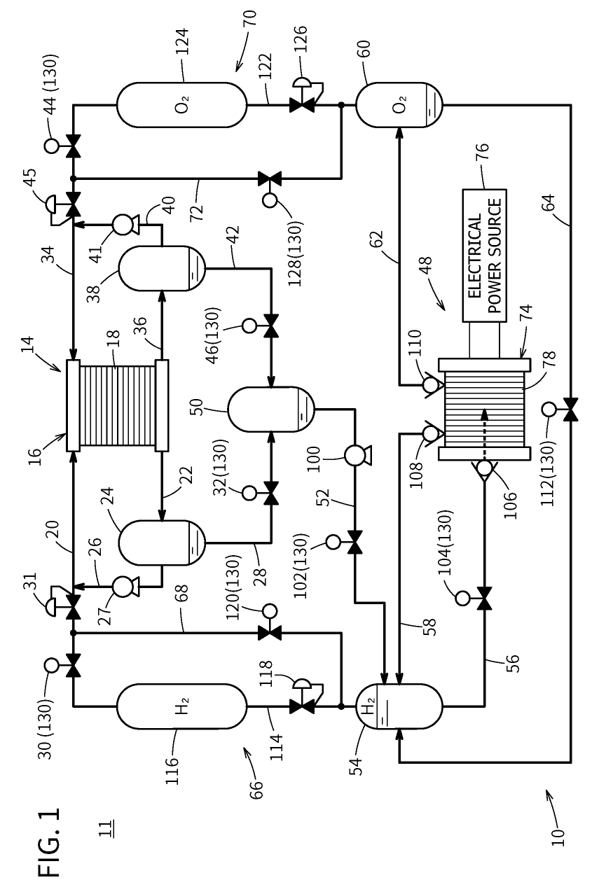

FIG. 1 is a schematic diagram of an energy system 11 equipped with a water electrolysis system 10. As shown in FIG. 1, the energy system 11 is a circulatory renewable energy system. The energysystem 11 is a system in which a fuel cell system 14 and the water electrolysis system 10 are combined. The fuel cell system 14 generates electrical power by an electrochemical reaction between the oxygen gas and the hydrogen gas. In the fuel cell system 14, the water is generated when the electrical power is generated. The water electrolysis system 10 electrolyzes the water and thereby causes the oxygen gas and the hydrogen gas to be generated. The water electrolysis system 10 utilizes the water (product water) that is generated by the fuel cell system 14. The fuel cell system 14 utilizes the oxygen gas and the hydrogen gas that are generated by the water electrolysis system 10.

Such an energy system 11 can be positioned, for example, on the Earth or on the surface of the moon. Further, the energy system 11 may also be installed on an artificial satellite such as the International Space Station (ISS) or the like.

The fuel cell system 14 is equipped with a fuel cell stack 16. The fuel cell stack 16 is a polymer electrolyte fuel cell (PEFC). The fuel cell stack 16 includes a plurality of power generation cells 18. The plurality of power generation cells 18 are stacked mutually on one another.

Although not illustrated, each of the power generation cells 18 includes a membrane electrode assembly (MEA), and a pair of separators. The membrane electrode assembly is sandwiched between the pair of separators. The membrane electrode assembly includes an electrolyte membrane, an anode, and a cathode. The electrolyte membrane is a polymer electrolyte membrane. The power generation cells 18 generate electrical power by an electrochemical reaction between the hydrogen gas that is supplied to the anode and the oxygen gas that is supplied to the cathode. By the power generation of the power generation cells 18, water is generated at the cathode.

The fuel cell system 14 is further equipped with a hydrogen gas supply path 20, a hydrogen gas discharge path 22, a gas-liquid separator 24, a hydrogen gas circulation path 26, and a first drainage path 28. The hydrogen gas supply path 20 supplies the hydrogen gas that is generated by the water electrolysis system 10 to the fuel cell stack 16. An opening/closing valve 30 and a back pressure valve 31 are disposed in the hydrogen gas supply path 20. The opening/closing valve 30 is a solenoid valve that opens and closes the hydrogen gas supply path 20. The back pressure valve 31 is positioned more on a downstream side than the opening/closing valve 30 in the hydrogen gas supply path 20. The back pressure valve 31 can maintain a constant supply pressure of the hydrogen gas to the fuel cell stack 16.

The hydrogen gas discharge path 22 connects the fuel cell stack 16 and the gas-liquid separator 24 to each other. A hydrogen containing exhaust gas (an off gas) that is discharged from the fuel cell stack 16 flows through the hydrogen gas discharge path 22. The hydrogen containing exhaust gas contains an unreacted hydrogen gas that has not reacted in the fuel cell stack 16. Further, the hydrogen containing exhaust gas also contains water (product water) that has permeated from the cathodes of the power generation cells 18 through electrolyte membranes90 to the anodes.

The gas-liquid separator 24 separates into a gas and a liquid the hydrogen containing exhaust gas that is guided from the hydrogen gas discharge path 22. Stated otherwise, the gas-liquid separator 24 removes moisture (water vapor) from the hydrogen containing exhaust gas. The gas-liquid separator 24 stores the water (liquid water) that is separated from the hydrogen containing exhaust gas. The hydrogen gas circulation path 26 returns the hydrogen containing exhaust gas, from which the water has been removed by the gas-liquid separator 24, to the hydrogen gas supply path 20. The hydrogen gas circulation path 26 is connected more on a downstream sideof the hydrogen gas supply path 20 than the back pressure valve 31. A pump 27 in order to deliver the hydrogen containing exhaust gas discharged from the fuel cell stack 16 to the hydrogen gas supply path 20 is disposed in the hydrogen gas circulation path 26.

The first drainage path 28 is a flow path for the purpose of discharging the water that is stored in the gas-liquid separator 24 to the exterior of the gas-liquid separator 24. An opening/closing valve 32 is disposed in the first drainage path 28. The opening/closing valve 32 is a solenoid valve that opens and closes the first drainage path 28.

The fuel cell system 14 is further equipped with an oxygen gas supply path 34, an oxygen gas discharge path 36, a gas-liquid separator 38, an oxygen gas circulation path 40, and a second drainage path 42. The oxygen gas supply path 34 supplies the oxygen gas that is generated by the water electrolysis system 10 to the fuel cell stack 16. An opening/closing valve 44 and a back pressure valve 45 are disposed in the oxygen gas supply path 34. The opening/closing valve 44 is a solenoid valve that opens and closes the oxygen gas supply path 34. The back pressure valve 45 is positioned more on a downstream side than the opening/closing valve 44 in the oxygen gas supply path 34. The back pressure valve 45 can maintain a constant supply pressure of the oxygen gas to the fuel cell stack 16.

The oxygen gas discharge path 36 connects the fuel cell stack 16 and the gas-liquid separator 38 to each other. An oxygen containing exhaust gas (an off gas) that is discharged from the fuel cell stack 16 flows through the oxygen gas discharge path 36. The oxygen containing exhaust gas contains an unreacted oxygen gas that has not reacted in the fuel cell stack 16. Further, the oxygen containing exhaust gas also contains water (product water) that is generated at the cathodes of the power generation cells 18.

The gas-liquid separator 38 separates into a gas and a liquid the oxygen containing exhaust gas that is guided from the oxygen gas discharge path 36. Stated otherwise, the gas-liquid separator 38 removes moisture (water vapor) from the oxygen containing exhaust gas. The gas-liquid separator 38 stores the water (liquid water) that is separated from the oxygen containing exhaust gas. The oxygen gas circulation path 40 returns the oxygen containing exhaust gas, from which the waterhas been removed by the gas-liquid separator 38, to the oxygen gas supply path 34. A pump 41 in order to deliver the oxygen containing exhaust gas discharged from the fuel cell stack 16 to the oxygen gas supply path 34 is disposed in the oxygen gas circulation path 40.

The second drainage path 42 is a flow path for the purpose of discharging the water that is stored in the gas-liquid separator 38 to the exterior of the gas-liquid separator 38. An opening/closing valve 46 is disposed in the second drainage path 42. The opening/closing valve 46 is a solenoid valve that opens and closes the second drainage path 42.

The fuel cell system 14 can be equipped with constituent elements apart from those described above. Specifically, the fuel cell system 14 can be equipped with, for example, a cooling device in order to allow a cooling medium to be circulated through the fuel cell stack 16.

The water electrolysis system 10 comprises a water electrolysis device 48, a water tank 50, a water inlet path 52, a first gas-liquid separator 54, a water supply path 56, a first outlet path 58, a second gas-liquid separator 60, a second outlet path 62, a water recovery path 64, a hydrogen gas storage unit 66, a first depressurization path 68, an oxygen gas storage unit 70, and a second depressurization path 72.

In the water electrolysis device 48, by the water being electrolyzed, the oxygen gas and the hydrogen gas are generated. The water electrolysis device 48 includes a water electrolysis stack 74, and an electrical power source 76. The water electrolysis stack 74, for example, is an isobaric (balanced) water electrolysis stack. Moreover, the water electrolysis stack 74 may also be a differential pressure type water electrolysis stack. The water electrolysis stack 74 includes a plurality of water electrolysis cells 78. The plurality of water electrolysis cells 78 are stacked mutually on one another.

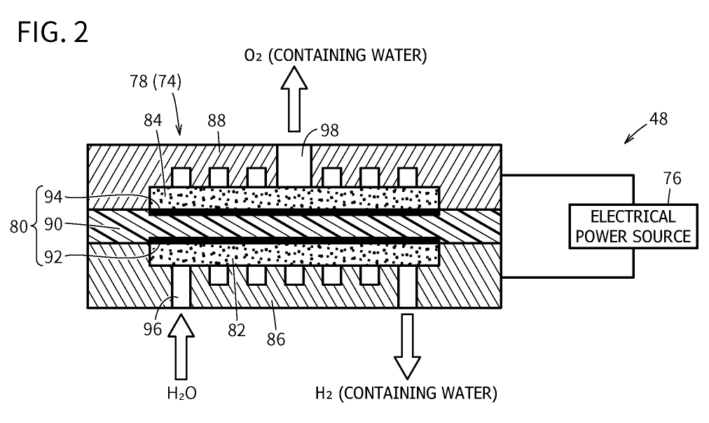

FIG. 2 is a schematic diagram of the water electrolysis cells 78. As shown in FIG. 2, the water electrolysis cells 78 comprise a membrane electrode assembly 80, a first current collector 82, a second current collector 84, a first support member 86, and a second support member 88. The membrane electrode assembly 80 includes the electrolyte membrane 90, a first electrode catalyst layer 92, and a second electrode catalyst layer 94. The membrane electrode assembly 80 is also referred to as a catalystcoated membrane (CCM). The electrolyte membrane 90 is an ion exchange membrane that is capable of exchanging ions. The electrolyte membrane 90, for example, is a proton exchange membrane (PEM). The electrolyte membrane 90 may also be an anion exchange membrane (AEM).

The first electrode catalyst layer 92 is stacked on one surface of the electrolyte membrane 90. The second electrode catalyst layer 94 is stacked on another surface of the electrolyte membrane 90. The first current collector 82 is stacked on the first electrode catalyst layer 92. The first current collector 82 is porous. The second current collector 84 is stacked on the second electrode catalyst layer 94. The second current collector 84 is porous.

The first support member 86 and the second support member 88 sandwich the electrolyte membrane 90 therebetween. A first flow path 96 is formed in the first support member 86. The first flow path 96 is adjacent to the first current collector 82. A second flow path 98 is formed in the second support member 88. The second flow path 98 is adjacent to the second current collector 84. The first flow path 96 and the second flow path 98 are disposed on both sides of the electrolyte membrane 90.

As shown in FIGS. 1 and 2, the electrical power source 76 supplies an electrical current (a directcurrent) to the water electrolysis stack 74. The electrical power source 76 applies a voltage acrossthe first current collector 82 and the second current collector 84 of the water electrolysis cell 78. The electrical power source 76 is a directcurrent power source.

As shown in FIG. 1, the water tank 50 is connected to the first drainage path 28 and the second drainage path 42. The water that is stored in the gas-liquid separator 24 is guided via the first drainage path 28 into the water tank 50. The water that is stored in the gas-liquid separator 38 is guided via the second drainage path 42 into the water tank 50.

The water inlet path 52 guides the water that is stored in the water tank 50 to the first gas-liquid separator 54. A pump 100 and an opening/closing valve 102 are disposed in the water inlet path 52. The pump 100 delivers the water that is stored in the water tank 50 to the first gas-liquid separator 54. The opening/closing valve 102 is a solenoid valve that opens and closes the water inlet path 52.

The first gas-liquid separator 54 is capable of storingthe water. The water supply path 56 guides the water that is stored in the first gas-liquid separator 54 to the water electrolysis stack 74. An opening/closing valve 104 and a check valve 106 are disposed in the water supply path 56. The opening/closing valve 104 is a solenoid valve that opens and closes the water supply path 56.

The check valve 106 allows the flow of fluid from the first gas-liquid separator 54 toward the water electrolysis stack 74, and prohibits the flow of fluid from the water electrolysis stack 74 toward the first gas-liquid separator 54. The check valve 106 is connected to the water electrolysis stack 74.

The first gas-liquid separator 54 is disposed at a position that is higher than the water electrolysis stack 74. More specifically, the water that is stored in the first gas-liquid separator 54 is guided by gravity via the water supply path 56 to the water electrolysis stack 74. In accordance therewith, since it is unnecessary to provide a pump in order to guide the water that is stored in the first gas-liquid separator 54 to the water electrolysis stack 74, the number of component parts in the water electrolysis system 10 can be reduced. Further, since electrical power for the purpose of driving the pump is unnecessary, it is possible to suppress a decrease in the energy efficiency of the water electrolysis system 10 (the energy system 11).

The first outlet path 58 connects the water electrolysis stack 74 and the first gas-liquid separator 54 to each other. The first outlet path 58 guides the hydrogen gas (containing water) that is generated in the water electrolysis stack 74 to the first gas-liquid separator 54. The first gas-liquid separator 54 separates into a gas and a liquid the hydrogen gas that is guided from the first outlet path 58. More specifically, the first gas-liquid separator 54 removes the waterfrom the hydrogen gas.

A check valve 108 is disposed in the first outlet path 58. The check valve 108 allows a flow of fluid from the water electrolysis stack 74 toward the first gas-liquid separator 54, and prohibits a flow of fluid from the first gas-liquid separator 54 toward the water electrolysis stack 74. The check valve 108 is connected to a hydrogen gas outlet provided on an upper end part of the water electrolysis stack 74.

The second gas-liquid separator 60 is capable of storing the water. The capacity of the second gas-liquid separator 60 is the same as the capacity of the first gas-liquid separator 54. The second outlet path 62 connects the water electrolysis stack 74 and the second gas-liquid separator 60 to each other. The second outlet path 62 guides the oxygen gas (containing water) that is generated in the water electrolysis stack 74 to the second gas-liquid separator 60. The second gas-liquid separator 60 separates into a gas and a liquid the oxygen gas that is guided from the second outlet path 62. More specifically, the second gas-liquid separator 60 removes the waterfrom the hydrogen gas.

A check valve 110 is disposed in the second outlet path 62. The check valve 110 allows a flow of fluid from the water electrolysis stack 74 toward the second gas-liquid separator 60, and prohibits a flow of fluid from the second gas-liquid separator 60 toward the water electrolysis stack 74. The check valve 110 is connected to an oxygen gas outlet provided on an upper end part of the water electrolysis stack 74.

The water recovery path 64 connects the first gas-liquid separator 54 and the second gas-liquid separator 60 to each other. An opening/closing valve 112 is disposed in the water recovery path 64. The opening/closing valve 112 is a solenoid valve that opens and closes the water recovery path 64.

The hydrogen gas storage unit 66 stores the hydrogen gas that has been separated fromthe water by the first gas-liquid separator 54. The hydrogen gas storage unit 66 includes a hydrogen gas inlet path 114, one hydrogen gas tank 116, and a first back pressure valve 118. The hydrogen gas inlet path 114 mutually connects the first gas-liquid separator 54 and the hydrogen gas tank 116 to each other. The hydrogen gas tank 116 can store a high pressure hydrogen gas. The hydrogen gas supply path 20 is connected to the hydrogen gas tank 116.

The capacity of the hydrogen gas tank 116 is greater than the capacity of the first gas-liquid separator 54. The first back pressure valve 118 opens in the case that the pressure of the hydrogen gas inside the first gas-liquid separator 54 is greater than or equal to a predetermined hydrogen gas pressure threshold value. The first back pressure valve 118 closes in the case that the pressure of the hydrogen gas inside the first gas-liquid separator 54 is less than the hydrogen gas pressure threshold value.

The first depressurization path 68 is a path in order to discharge the hydrogen gas from inside the first gas-liquid separator 54, and to cause the pressure inside the first gas-liquid separator 54 to be reduced. One end of the first depressurization path 68 is connected to a portion between the first gas-liquid separator 54 and the first back pressure valve 118 in the hydrogen gas inlet path 114. Another end of the first depressurization path 68 is connected to the portion between the opening/closing valve 30 and the back pressure valve 31 in the hydrogen gas supply path 20. An opening/closing valve 120 is disposed in the first depressurization path 68. The opening/closing valve 120 is a solenoid valve that opens and closes the first depressurization path 68.

The oxygen gas storage unit 70 stores the oxygen gas that has been separated from the water by the second gas-liquid separator 60. The oxygen gas storage unit 70 includes an oxygen gas inlet path 122, one oxygen gas tank 124, and a second back pressure valve 126. The oxygen gas inlet path 122 mutually connects the second gas-liquid separator 60 and the oxygen gas tank 124 to each other. The oxygen gas tank 124 can store a high pressure oxygen gas. The oxygen gas supply path 34 is connected to the oxygen gas tank 124.

The capacity of the oxygen gas tank 124 is greater than the capacity of the second gas-liquid separator 60. The capacity of the oxygen gas tank 124 is the same as the capacity of the hydrogen gas tank 116. The second back pressure valve 126 opens in the case that the pressure of the oxygen gas inside the second gas-liquid separator 60 is greater than or equal to a predetermined oxygen gas pressure threshold value. The second back pressure valve 126 closes in the case that the pressure of the oxygen gas inside the second gas-liquid separator 60 is less than the oxygen gas pressure threshold value.

The second depressurization path 72 is a path in order to discharge the oxygen gas from inside the second gas-liquid separator 60, and to cause the pressure inside the second gas-liquid separator 60 to be reduced. One end of the second depressurization path 72 is connected to a portion between the second gas-liquid separator 60 and the second back pressure valve 126 in the oxygen gas inlet path 122. Another end of the second depressurization path 72 is connected to the portion between the opening/closing valve 44 and the back pressure valve 45 in the oxygen gas supply path 34. An opening/closing valve 128 is disposed in the second depressurization path 72. The opening/closing valve 128 is a solenoid valve that opens and closes the second depressurization path 72.

The water electrolysis system 10 can be equipped with constituent elements apart from those described above. In the following explanation, the aforementioned opening/closing valves 30, 32, 44, 46, 102, 104, 112, 120, and 128 may be simply referred to as "opening/closing valves 130".

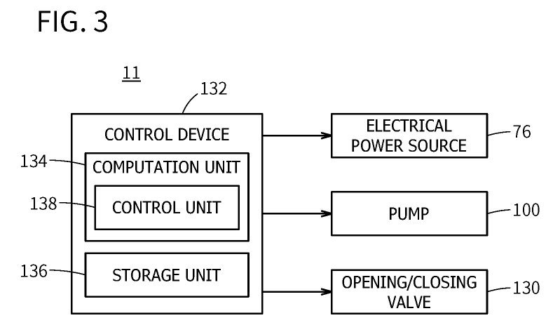

FIG. 3 is a block diagram of a control device 132. As shown in FIG. 3, the energy system 11 may include the control device 132 that serves to control the entirety of the fuel cell system 14 and the water electrolysis system 10. The control device 132 includes a computation unit 134 and a storage unit 136. The computation unit 134 is constituted by a processor such as a CPU (Central Processing Unit) or a GPU (Graphics Processing Unit) or the like. More specifically, the computation unit 134 is constituted by a processing circuit (processing circuitry).

The computation unit 134 includes a control unit 138. The control unit 138 is responsible for the overall control of the energy system 11. The control unit 138 controls the electrical power source 76, the pump 100, and the opening/closing valve 130.

The control unit 138 can be realized by the execution of a program that is stored in the storage unit 136 by the computation unit 134. Moreover, at least a portion of the control unit 138 may be realized by an integrated circuit such as an ASIC (Application Specific Integrated Circuit) or an FPGA (Field-Programmable Gate Array) or the like. Further, at least a portion of the control unit 138 may be realized by an electronic circuit including a discrete device.

The storage unit 136 is constituted by a non-illustrated volatile memory, and a non-illustrated non-volatile memory. As the volatile memory, there may be cited a RAM (Random Access Memory) or the like. The volatile memory is used as a working memory of the processor, and temporarily stores data and the like required for processing or calculations. As an example of the non-volatile memory, there may be cited a ROM (Read Only Memory) or a flash memory or the like. The non-volatile memory is used as a storage memory, and serves to store a program, a table, a map, and the like. At least a portion of the storage unit 136 may be provided in the aforementioned processor, the integrated circuit, or the like.

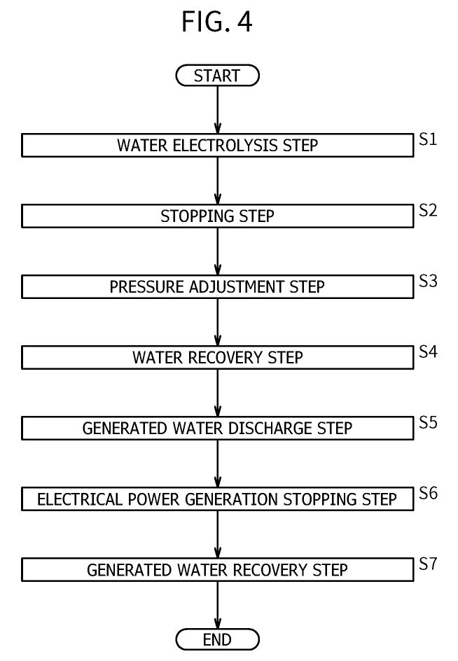

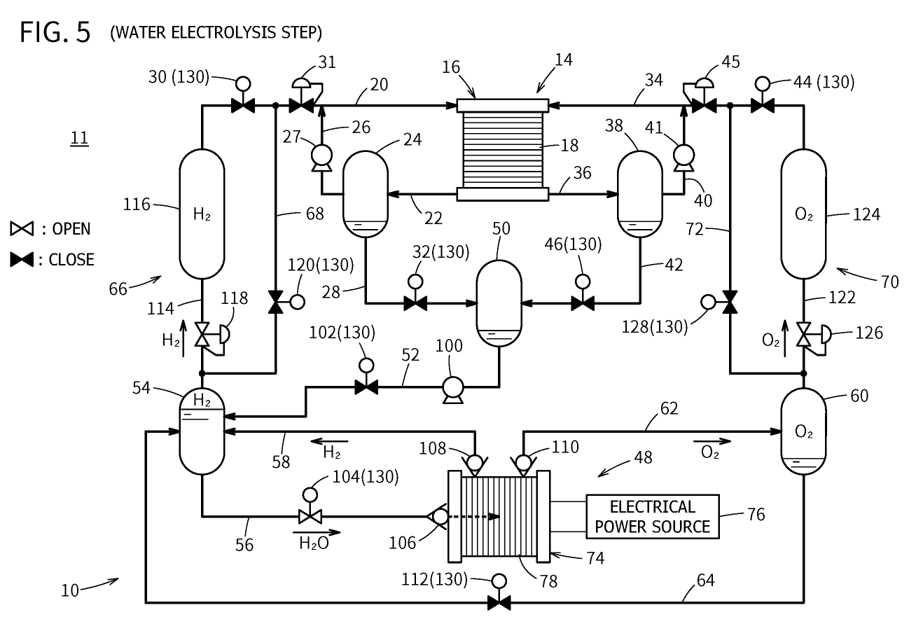

Next, a description will be given concerning a control method for the water electrolysis system 10. Moreover, in an initial state, the opening/closing valves 130 are in a closed state. FIG. 4 is a flowchart for describing the control method for the water electrolysis system 10. FIGS. 5-10 are explanatory diagrams of the control method for the water electrolysis system 10. As shown in FIG. 4, in step S1, a water electrolysis step is carried out. In the water electrolysis step, the water that is stored in the first gas-liquid separator 54 is supplied to the water electrolysis stack 74 via the water supply path 56, and together therewith, by supplying an electrical current to the water electrolysis stack 74, the hydrogen gas and the oxygen gas are generated, and the hydrogen gas is guided to the first gas-liquid separator 54 and the oxygen gas is guided to the second gas-liquid separator 60.

Specifically, as shown in FIG. 5, in the water electrolysis step, the control unit 138 controls the opening/closing valve 104, and thereby causes the water supply path 56 to open. Upon doing so, the water that is stored in the first gas-liquid separator 54, due to gravity (potential energy), flows down via the water supply path 56 to the water electrolysis stack 74. The water that is guided to the water electrolysis stack 74 is then guided to the first flow path 96 of the water electrolysis cells 78. In accordance therewith, the water supply path 56, the first flow path 96 of the water electrolysis cells 78, and the first outlet path 58 are filled with water. A portion of the water that has been guided to the first flow path 96, due to water pressure, permeates through the electrolyte membrane 90 from the first electrode catalyst layer 92 toward the second electrode catalyst layer 94.

When an electrical current is supplied from the electrical power source 76 to the water electrolysis stack 74 and a voltage is applied between the first current collector 82 and the second current collector 84, in the second electrode catalyst layer 94, the water is subjected to electrolysis and hydrogen ions (protons) and oxygen gas are generated. The hydrogen ions that are generated in the second electrode catalyst layer 94 permeate through the electrolyte membrane 90 and are guided to the first electrode catalyst layer 92. In the first electrode catalyst layer 92, hydrogen gas is generated from the hydrogen ions.

The hydrogen gas that is generated in the first electrode catalyst layer 92, due to buoyancy, separates away from the first electrode catalyst layer 92 and the first current collector 82 and the like, thereby opening the check valve 108 and being guided via the first outlet path 58 to the first gas-liquid separator 54. The hydrogen gas that is guided to the first gas-liquid separator 54 contains moisture. The oxygen gas that is generated in the second electrode catalyst layer 94 opens the check valve 110, and is guided via the second outlet path 62 to the second gas-liquid separator 60.

The ratio of the amount (the amount of substance) of the hydrogen gas to the amount (the amount of substance) of the oxygen gas generated in the water electrolysis stack 74 is 2:1. More specifically, the amount of hydrogen gas generated per unit time in the water electrolysis stack 74 is twice the amount of oxygen gas generated per unit time in the water electrolysis stack 74. Further, the capacity of the first gas-liquid separator 54 and the capacity of the second gas-liquid separator 60 are the same as each other.

In this case, in the water electrolysis step, the pressure of the hydrogen gas inside the first gas-liquid separator 54 becomes higher than the pressure of the oxygen gas inside the second gas-liquid separator 60. Stated otherwise, a differential pressure is generated between the pressure of the hydrogen gas inside the first gas-liquid separator 54 and the pressure of the oxygen gas inside the second gas-liquid separator 60. Due to such a differential pressure, the water supplied to the first flow path 96 can be made to efficiently permeate through the electrolyte membrane 90.

According to the present embodiment, the control unit 138 controls the electrical current that is supplied to the water electrolysis stack 74 based on the differential pressure between the hydrogen gas inside the first gas-liquid separator 54 and the oxygen gas inside the second gas-liquid separator 60. In accordance therewith, the hydrogen gas and the oxygen gas can be efficiently generated by the water electrolysis stack 74.

In the water electrolysis system 10, when the pressure of the hydrogen gas inside the first gas-liquid separator 54 reaches the hydrogen gas pressure threshold value of the first back pressure valve 118, the hydrogen gas inside the first gas-liquid separator 54 is guided via the first back pressure valve 118 to the hydrogen gas tank 116. In accordance therewith, the hydrogen gas is stored under pressure in the hydrogen gas tank 116. Further, when the pressure of the oxygen gas inside the second gas-liquid separator 60 reaches the oxygen gas pressure threshold value of the second back pressure valve 126, the oxygen gas inside the second gas-liquid separator 60 is guided via the second back pressure valve 126 to the oxygen gas tank 124. In accordance therewith, the oxygen gas is stored under pressure in the oxygen gas tank 124.

According to the present embodiment, the hydrogen gas pressure threshold value is set to a pressure that is higher than that of the oxygen gas pressure threshold value. More specifically, the pressure of the hydrogen gas inside the hydrogen gas tank 116 is greater than the pressure of the oxygen gas inside the oxygen gas tank 124. The hydrogen gas pressure threshold value and the oxygen gas pressure threshold value can be set as appropriate. According to the present embodiment, for example, in the case that the pressure of the hydrogen gas inside the hydrogen gas tank 116 reaches a predetermined set hydrogen pressure, or alternatively, in the case that the pressure of the oxygen gas inside the oxygen gas tank 124 has reached a predetermined set oxygen pressure, the water electrolysis step comes to an end.

In this manner, in the water electrolysis step, the hydrogen gas that is guided from the water electrolysis stack 74 to the first gas-liquid separator 54 isstored under pressure in the hydrogen gas tank 116 andthe oxygen gas that is guided from the water electrolysis stack 74 to the second gas-liquid separator 60 is stored under pressure in the oxygen gas tank 124. In accordance therewith, as will be discussed later, the fuel cell stack 16 is capable of stably generating electrical power by using the hydrogen gas that is stored under pressure in the hydrogen gas tank 116 and the oxygen gas that is stored under pressure in the oxygen gas tank 124. After step S1, the process transitions to step S2.

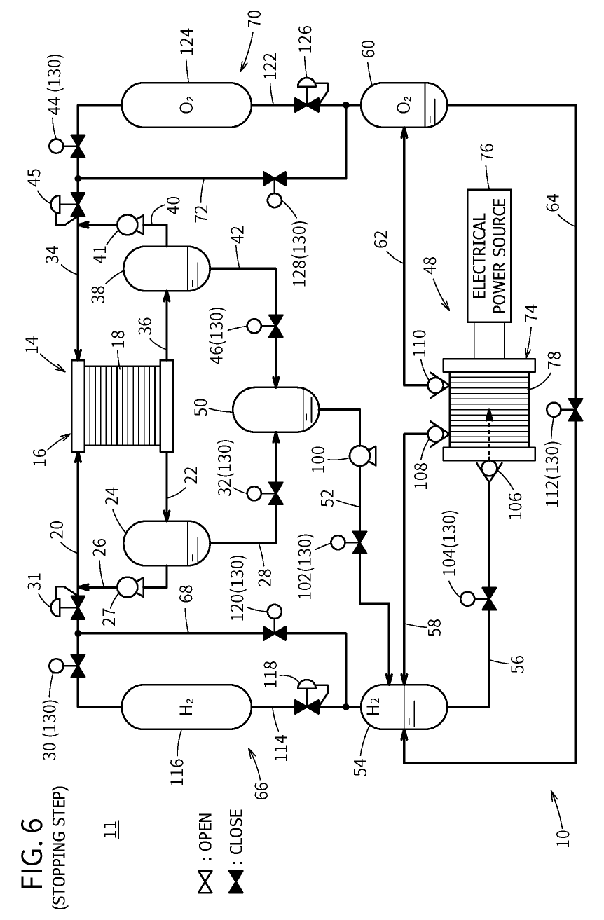

In step S2, a stopping step is carried out. In the stopping step, the water electrolysis of the water electrolysis stack 74 is stopped. Specifically, the control unit 138 controls the electrical power source 76, and thereby causes the supply of the electrical current to the water electrolysis stack 74 to stop. Further, as shown in FIG. 6, the control unit 138 controls the opening/closing valve 104, and thereby causes the water supply path 56 to close. In accordance therewith, the supply of the water from the first gas-liquid separator 54 to the water electrolysis stack 74 is stopped. In this case, since the differential pressure remains inside the water electrolysis stack 74, the water permeates through the electrolyte membrane 90, and is used when the next water electrolysis starts. After step S2, the process transitions to step S3.

In step S3, a pressure adjustment step is carried out. In the pressure adjustment step, the pressure of the hydrogen gas inside the first gas-liquid separator 54 is adjusted in a manner so as to become a pressure that is lower than the pressure of the oxygen gas inside the second gas-liquid separator 60. Stated otherwise, in the pressure adjustment step, by the hydrogen gas inside the first gas-liquid separator 54 and the oxygen gas inside the second gas-liquid separator 60 being consumed by the fuel cell stack 16, the pressure of the hydrogen gas inside the first gas-liquid separator 54 becomes lower than the pressure of the oxygen gas inside the second gas-liquid separator 60. Specifically, in the pressure adjustment step, in a state in which the supply of the hydrogen gas from the hydrogen gas tank 116 to the fuel cell stack 16 has been stopped, the hydrogen gas is supplied to the fuel cell stack 16 from the first gas-liquidseparator 54, and further, the oxygen gas is supplied to the fuel cell stack 16 from both the oxygen gas tank 124 and the second gas-liquid separator 60. In this case, with a simple method, the pressure of the hydrogen gas inside the first gas-liquid separator 54 can be made lower than the pressure of the oxygen gas inside the second gas-liquid separator 60.

More specifically, in the pressure adjustment step, by the hydrogen gas inside the first gas-liquid separator 54 and the oxygen gas inside the second gas-liquid separator 60 being guided to the fuel cell stack 16, the fuel cell stack 16 is made to generate electrical power. In accordance therewith, since the electrical power can be generated using the hydrogen gas inside the first gas-liquid separator 54 and the oxygen gas inside the oxygen gas tank 124 and the second gas-liquid separator 60, the energy can be effectively utilized.

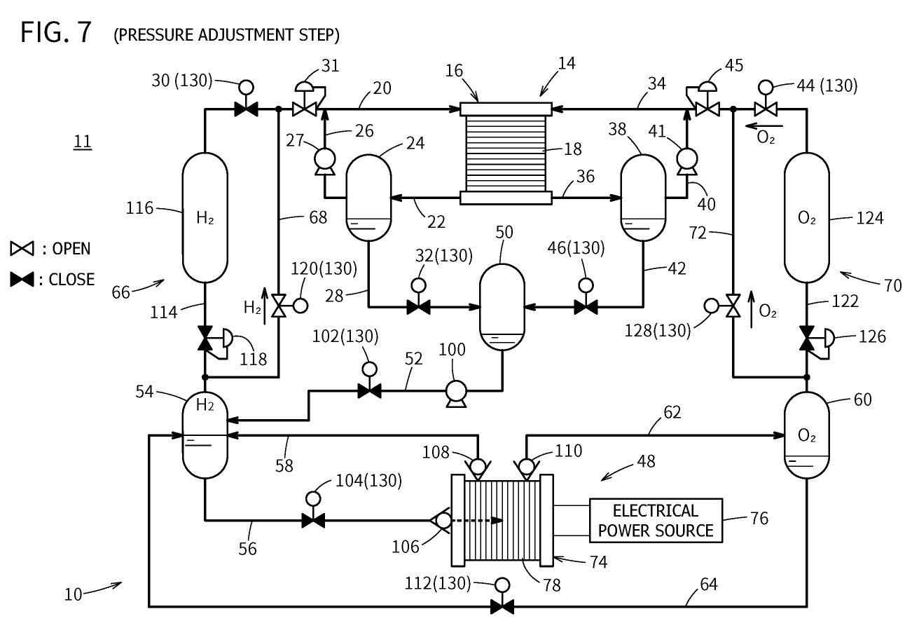

Specifically, as shown in FIG. 7, the control unit 138 controls the opening/closing valve 120 and thereby causes the first depressurization path 68 to open. In accordance therewith, the hydrogen gas inside the first gas-liquid separator 54 is guided to the fuel cell stack 16 via the first depressurization path 68 and the hydrogen gas supply path 20. Furthermore, the control unit 138 controlsthe opening/closing valve 128 and thereby causes the second depressurization path 72 to open, andcontrols the opening/closing valve 44 and thereby causes the oxygen gas supply path 34 to open. In accordance therewith, the oxygen gas inside the second gas-liquid separator 60 issupplied to the fuel cell stack 16 via the second depressurization path 72 and the oxygen gas supply path 34, and the oxygen gas inside the oxygen gas tank 124 is supplied via the oxygen gas supply path 34 to the fuel cell stack 16. The fuel cell stack 16 generates electrical power by an electrochemical reaction between the hydrogen gas and the oxygen gas.

A hydrogen containing exhaust gas (containing water) that is discharged from the fuel cell stack 16 is guided via the hydrogen gas discharge path 22 to the gas-liquid separator 24 and is separated into a gas and a liquid. Water is stored inside the gas-liquid separator 24. More specifically, the water level inside the gas-liquid separator 24 rises. The hydrogen containing exhaust gas from which the waterhas been removed in the gas-liquid separator 24 is introduced into the hydrogen gas supply path 20 via the hydrogen gas circulation path 26.

An oxygen containing exhaust gas (containing water) that is discharged from the fuel cell stack 16 is guided via the oxygen gas discharge path 36 to the gas-liquid separator 38 and is separated into a gas and a liquid. Water is stored inside the gas-liquid separator 38. More specifically, the water level inside the gas-liquid separator 38 rises. The oxygen containing exhaust gas from which the waterhas been removed in the gas-liquid separator 38 is introduced into the oxygen gas supply path 34 via the oxygen gas circulation path 40.

According to the present embodiment, the ratio of the hydrogen gas to the oxygen gas consumed in the fuel cell stack 16 is 2:1. Since the hydrogen gas is supplied from the first gas-liquid separator 54, and the oxygen gas is supplied from both the oxygen gas tank 124 and the second gas-liquid separator 60, the discharge rate (the amount of substance) of the hydrogen gas per unit time inside the first gas-liquid separator 54 is greater than the discharge rate (the amount of substance) of the oxygen gas per unit time inside the second gas-liquid separator 60. Stated otherwise, the pressure declining rate of the hydrogen gas inside the first gas-liquid separator 54 is greater than the pressure declining rate of the oxygen gas inside the second gas-liquid separator 60. In accordance therewith, even if the pressure in the first gas-liquid separator 54 is greater than or equal to two times the pressure in the second gas-liquid separator 60, the pressure of the hydrogen gas inside the first gas-liquid separator 54 becomes lower than the pressure of the oxygen gas inside the second gas-liquid separator 60. Further, regardless of the amount of water inside the first gas-liquid separator 54 and the second gas-liquid separator 60, the pressure of the hydrogen gas inside the first gas-liquid separator 54 becomes lower than the pressure of the oxygen gas inside the second gas-liquid separator 60. According to the present embodiment, for example, in the case that the differential pressure between the pressure of the oxygen gas inside the second gas-liquid separator 60 and the pressure of the hydrogen gas inside the first gas-liquid separator 54 has become a predetermined pressure, the pressure adjustment step comes to an end. Moreover, for example, in the case that the pressure in the first gas-liquid separator 54 has decreased to a preset pressure, the pressure adjustment step may come to an end. After step S3, the process transitions to step S4.

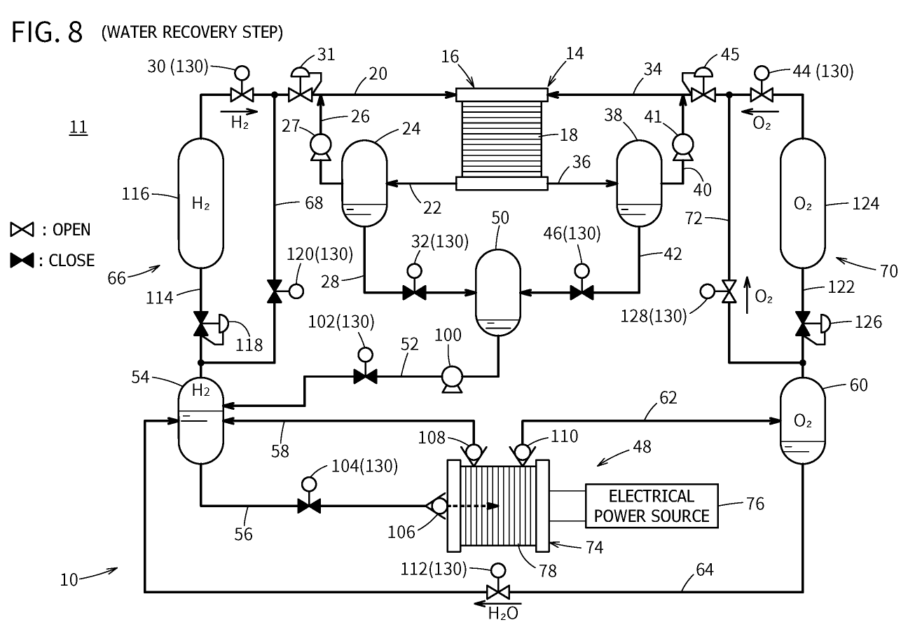

In step S4, a water recovery step is carried out. In the water recovery step, due to the differential pressure between the pressure of the hydrogen gas inside the first gas-liquid separator 54 and the pressure of the oxygen gas inside the second gas-liquid separator 60, the water that is stored in the second gas-liquid separator 60 is returned via the water recovery path 64 to the first gas-liquid separator 54. Specifically, as shown in FIG. 8, the control unit 138 controls the opening/closing valve 112 and thereby causes the water recovery path 64 to open. In accordance therewith, the water that is stored inside the second gas-liquid separator 60 is pushed out toward the water recovery path 64 by the oxygen gas inside the second gas-liquid separator 60. Therefore, the water that is stored inside the second gas-liquid separator 60 is returned via the water recovery path 64 to the interior of the first gas-liquid separator 54.

Further, the control unit 138 controlsthe opening/closing valve 120 and thereby causes the first depressurization path 68 to close, and controls the opening/closing valve 30 and thereby causes the hydrogen gas supply path 20 to open. In accordance therewith, the hydrogen gas inside the hydrogen gas tank 116 is supplied via the hydrogen gas supply path 20 to the fuel cell stack 16. Therefore, since an insufficiency of the hydrogen gas supplied to the fuel cell stack 16 can be avoided, the electrical power generation of the fuel cell stack 16 can be continued during the water recovery step.

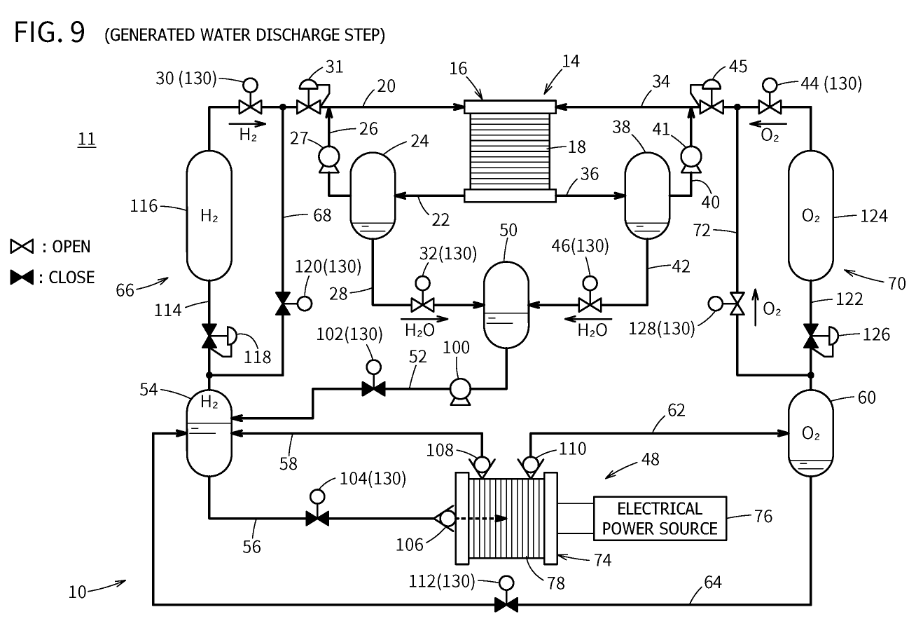

In this embodiment, the water recovery step comes to an end, for example, in the case that the water level inside the second gas-liquid separator 60 has reached a predetermined lower limit value. When the water recovery step is completed, the control unit 138 controls the opening/closing valve 112 and thereby causes the water recovery path 64 to close (refer to FIG. 9). After step S4, the process transitions to step S5.

In step S5, a generated water discharge step is carried out. In the generated water discharge step, the generated water, which is water that is generated in the fuel cell stack 16, is discharged from the fuel cell system 14 to the water electrolysis system 10. Specifically, as shown in FIG. 9, when the water level inside the gas-liquid separator 24 reaches a predetermined value, the control unit 138 controls the opening/closing valve 32 and thereby causes the first drainage path 28 to open. The water that is stored inside the gas-liquid separator 24, due to the differential pressure between the pressure of the hydrogen gas inside the gas-liquid separator 24 and the pressure (negative pressure) inside the water tank 50, is discharged via the first drainage path 28 into the water tank 50.

Further, when the water level inside the gas-liquid separator 38 reaches a predetermined value, the control unit 138 controls the opening/closing valve 46 and thereby causes the second drainage path 42 to open. The water that is stored inside the gas-liquid separator 38, due to the differential pressure between the pressure of the oxygen gas inside the gas-liquid separator 38 and the pressure (negative pressure) inside the water tank 50, is discharged via the second drainage path 42 into the water tank 50.

In the case that the water level inside the gas-liquid separator 24 has reached a predetermined lower limit water level, the control unit 138 controls the opening/closing valve 32 and thereby causes the first drainage path 28 to close. Further, in the case that the water level inside the gas-liquid separator 38 has reached the predetermined lower limit water level, the control unit 138 controls the opening/closing valve 46 and thereby causes the second drainage path 42 to close. By the first drainage path 28 and the second drainage path 42 being closed, the generated water discharge step comes to an end. After step S5, the process transitions to step S6.

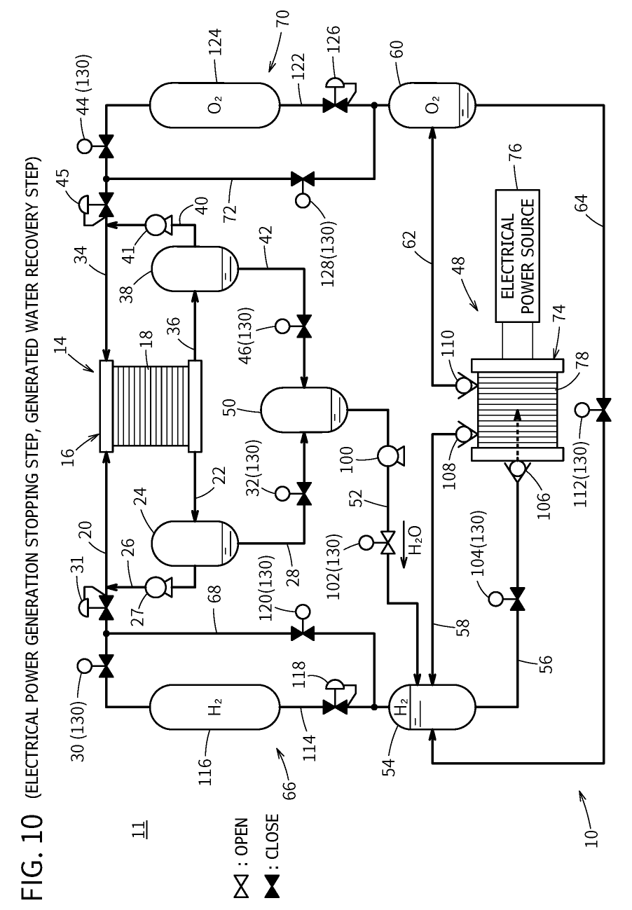

In step S6, an electrical power generation stopping step is carried out. In the electrical power generation stopping step, the electrical power generation of the fuel cell stack 16 is stopped. Specifically, the control unit 138 cuts off the generation of the electrical current, and as shown in FIG. 10, controlsthe opening/closing valve 30 and thereby causesthe hydrogen gas supply path 20 to close, and controls the opening/closing valve 128 and the opening/closing valve 44 and thereby causes the oxygen gas supply path 34 to close. In accordance therewith, the supply of the hydrogen gas and the oxygen gas to the fuel cell stack 16 is stopped. From the standpoint of suppressing degradation of the catalyst, the control unit 138 may control the opening/closing valve 30, and thereby cause the hydrogen gas supply path 20 to closeafter the oxygen in the oxygen gas supply path 34 has been consumed. The electrical power generation stopping step comes to an end by the electrical power generation of the fuel cell stack 16 being stopped. After step S6, the process transitions to step S7.

In step S7, a generated water recovery step is carried out. In the generated water recovery step, the water that is stored in the water tank 50 is recovered inside the first gas-liquid separator 54. Specifically, the control unit 138 controls the opening/closing valve 102 to thereby cause the water inlet path 52 to open, causes the pump 100 to be driven, and thereby delivers the water that is stored in the water tank 50 to the first gas-liquid separator 54. In the case that the water level inside the water tank 50 has reached a predetermined lower limit water level, the control unit 138 causes the pump 100 to stop, and controls the opening/closing valve 102 and thereby causes the water inlet path 52 to close (refer to FIG. 1). Thereafter, the present flowchart is concluded.

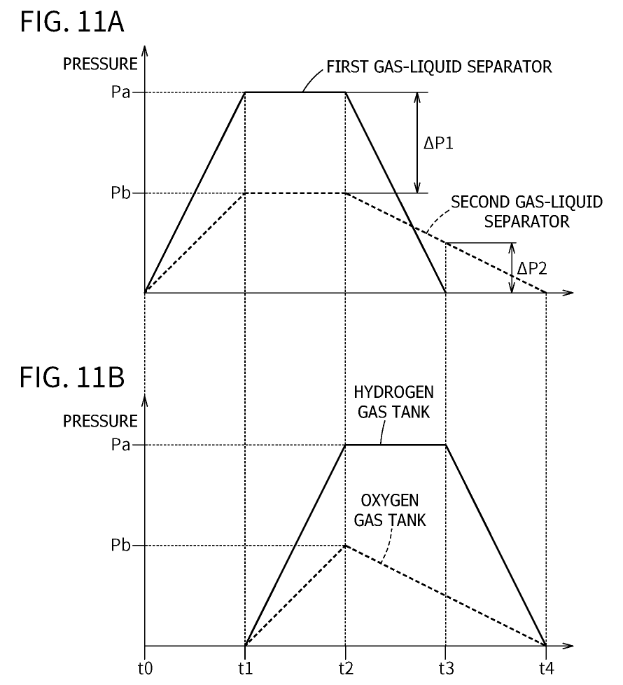

Next, with reference to FIGS. 11A and 11B, a further description will be given concerning the present embodiment. FIG. 11A is a graph showing changes in the pressure of the hydrogen gas inside the first gas-liquid separator 54 and changes in the pressure of the oxygen gas inside the second gas-liquid separator 60 in the water electrolysis system 10 shown in FIG. 1. FIG. 11B is a graph showing changes in the pressure of the hydrogen gas inside the hydrogen gas tank 116 and changes in the pressure of the oxygen gas inside the oxygen gas tank 124 in the water electrolysis system 10 shown in FIG. 1.

As shown in FIGS. 11A and 11B, according to the present embodiment, the water electrolysis step is carried out from time t0 to time t2. When the water electrolysis step (step S1) is started at time t0, the pressure of the hydrogen gas inside the first gas-liquid separator 54 and the pressure of the oxygen gas inside the second gas-liquid separator 60 gradually rise. In the water electrolysis step, the amount (the amount of substance) of the hydrogen gas that is generated in the water electrolysis stack 74 is two times the amount (the amount of substance) of the oxygen gas that is generated in the water electrolysis stack 74. Therefore, in the water electrolysis step, the rate of increase in the pressure of the hydrogen gas inside the first gas-liquid separator 54 becomes greater than the rate of increase of the pressure of the oxygen gas inside the second gas-liquid separator 60.

Thereafter, at time t1, when the pressure of the hydrogen gas inside the first gas-liquid separator 54 reaches the hydrogen gas pressure threshold value (the pressure Pa) of the first back pressure valve 118, the hydrogen gas inside the first gas-liquid separator 54 is introduced into the hydrogen gas tank 116. In accordance therewith, the hydrogen gas is stored under pressure in the hydrogen gas tank 116. Further, at time t1, when the pressure of the oxygen gas inside the second gas-liquid separator 60 reaches the oxygen gas pressure threshold value (the pressure Pb) of the second back pressure valve 126, the oxygen gas inside the second gas-liquid separator 60 is introduced into the oxygen gas tank 124. In accordance therewith, the oxygen gas is stored under pressure in the oxygen gas tank 124.

Thereafter, at time t2, the pressure of the hydrogen gas inside the hydrogen gas tank 116 reachesthe set hydrogen pressure (the pressure Pa) and the pressure of the oxygen gas inside the oxygen gas tank 124 reaches the set oxygen pressure (the pressure Pb). In accordance therewith, the storage under pressure of the hydrogen gas inside the hydrogen gas tank 116 and the storage under pressure of the oxygen gas inside the oxygen gas tank 124 is completed. At time t2, the stopping step (step S2) is carried out.

Between a period from time t1 to time t2, the pressure of the hydrogen gas inside the first gas-liquid separator 54 ismaintained at the pressure Pa andthe pressure of the oxygen gas inside the second gas-liquid separator 60 is maintained at the pressure Pb. According to the present embodiment, the pressure Pa is greater than the pressure Pb. More specifically, a differential pressure ΔP1 is generated between the pressure of the hydrogen gas inside the first gas-liquid separator 54 and the pressure of the oxygen gas inside the second gas-liquid separator 60. Due to such a differential pressure ΔP1 being generated, the water that is supplied to the first flow path 96 of the water electrolysis stack 74 passes through the electrolyte membrane 90 and becomes more easily guided to the second flow path 98 (the second electrode catalyst layer 94). Therefore, in the water electrolysis stack 74, the water electrolysis can be carried out efficiently.

From timet2 until timet3, the pressure adjustment step (step S3) is carried out. In the pressure adjustment step, the pressure declining rate of the hydrogen gas inside the first gas-liquid separator 54 is greater than the pressure declining rate of the oxygen gas inside the second gas-liquid separator 60. In the pressure adjustment step, the pressure of the hydrogen gas inside the hydrogen gas tank 116 does not decrease. In the pressure adjustment step, the pressure of the oxygen gas inside the oxygen gas tank 124 decreases.

In this case, in the pressure adjustment step, the pressure of the hydrogen gas inside the first gas-liquid separator 54 decreases more than the pressure of the oxygen gas inside the second gas-liquid separator 60. At time t3, a differential pressure ΔP2 between the pressure of the hydrogen gas inside the first gas-liquid separator 54 and the pressure of the oxygen gas inside the second gas-liquid separator 60 is generated.

At time t3, the water recovery step (step S4) is started. In the water recovery step, by means of the differential pressure ΔP2, the water that is stored inside the second gas-liquid separator 60 is returned via the water recovery path 64 to the interior of the first gas-liquid separator 54. During the generation of electrical power by the fuel cell stack 16, the generated water discharge step (step S5) is carried out. The generated water discharge step may be carried out in a state prior to the completion of the water recovery step. In the generated water discharge step, the pressure of the hydrogen gas (the hydrogen exhaust gas) that is introduced from the hydrogen gas tank 116 via the fuel cell stack 16 into the interior of the gas-liquid separator 24 is used to discharge the water that is stored inside the gas-liquid separator 24 into the water tank 50. Further, the pressure of the oxygen gas (the oxygen exhaust gas) that is introduced from the second gas-liquid separator 60 and the oxygen gas tank 124 via the fuel cell stack 16 into the interior of the gas-liquid separator 38 is used to discharge the water that is stored inside the gas-liquid separator 38 into the water tank 50.

After the generated water discharge step, at time t4, the electrical power generation stopping step (step S6) is carried out. Thereafter, the generated water recovery step (step S7) is carried out.

According to the present disclosure, due to the differential pressure ΔP2 between the pressure of the hydrogen gas inside the first gas-liquid separator 54 and the pressure of the oxygen gas inside the second gas-liquid separator 60, the water that is stored in the second gas-liquid separator 60 can be returned to the first gas-liquid separator 54. In accordance therewith, there is no necessity to provide a pump in the water recovery path 64 in order to return the water that is stored inside the second gas-liquid separator 60 to the first gas-liquid separator 54. Accordingly, a decrease in energy efficiency can be suppressed. Thus, it is possible to obtain a more satisfactory control method for the water electrolysis system 10.

### First Exemplary Modification

Next, a description will be given concerning a water electrolysis system 10A according to a first exemplary modification. In the water electrolysis system 10A according to the first exemplary modification, the same constituent elements as those of the above-described water electrolysis system 10 are denoted by the same reference numerals, and redundant explanations of such features will be omitted.

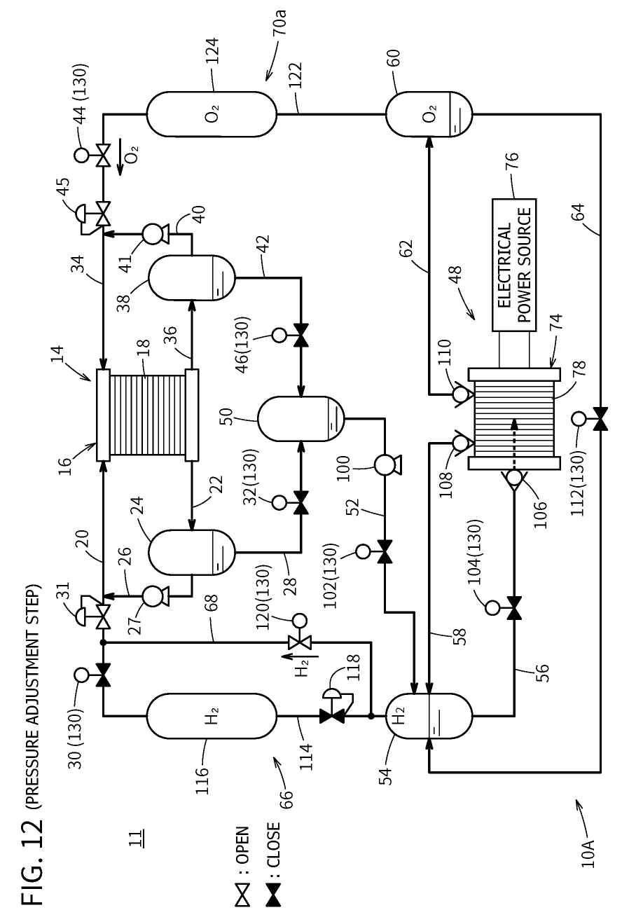

FIG. 12 is a schematic diagram of the energy system 11 equipped with the water electrolysis system 10A according to the first exemplary modification. As shown in FIG. 12, the water electrolysis system 10A comprises an oxygen gas storage unit 70a instead of the oxygen gas storage unit 70. The oxygen gas storage unit 70a is not equipped with the aforementioned second back pressure valve 126. Furthermore, in the water electrolysis system 10A, the second depressurization path 72 and the opening/closing valve 128 described above are omitted. The interior of the second gas-liquid separator 60 is constantly in communication with the oxygen gas tank 124 via the oxygen gas inlet path 122.

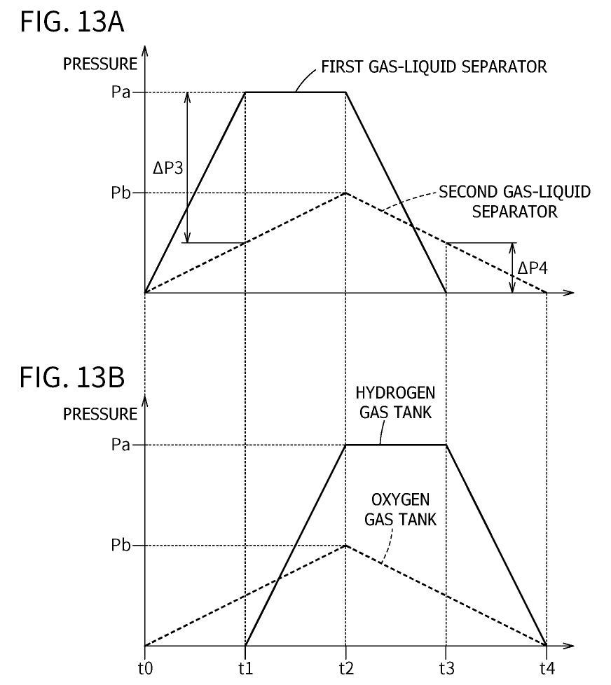

FIG. 13A is a graph showing changes in the pressure of the hydrogen gas inside the first gas-liquid separator 54 and changes in the pressure of the oxygen gas inside the second gas-liquidseparator 60 in the water electrolysis system 10A shown in FIG. 12. FIG. 13B is a graph showing changes in the pressure of the hydrogen gas inside the hydrogen gas tank 116 and changes in the pressure of the oxygen gas inside the oxygen gas tank 124 in the water electrolysis system 10A shown in FIG. 12. As shown in FIGS. 13A and 13B, according to the present exemplary modification, the changes in the pressure of the hydrogen gas inside the first gas-liquid separator 54 and the changes in the pressure of the hydrogen gas inside the hydrogen gas tank 116 are the same as those in the above-described water electrolysis system 10.

According to the present exemplary modification, the second gas-liquid separator 60 and the oxygen gas tank 124 are constantly in communication with each other, and therefore, when the water electrolysis step is started, the oxygen gas generated in the water electrolysis stack 74 is introduced via the second gas-liquid separator 60 into the oxygen gas tank 124. Therefore, from time t0 until time t2, the pressure of the oxygen gas inside the second gas-liquid separator 60 and the pressure of the oxygen gas inside the oxygen gas tank 124 gradually rise. In this case, since the rate of increase in the pressure of the oxygen gas inside the second gas-liquid separator 60 is comparatively small, at time t1, the pressure inside the second gas-liquid separator 60 is less than the pressure Pb.

Therefore, at time t1, a differential pressure ΔP3 between the pressure of the hydrogen gas inside the first gas-liquid separator 54 and the pressure of the oxygen gas inside the second gas-liquid separator 60 is greater than the above-described differential pressure ΔP1. In this case, the water that is supplied from the first gas-liquid separator 54 to the water electrolysis stack 74 can be efficiently guided to the second electrode catalyst layer 94. At time t2, the pressure of the oxygen gas inside the second gas-liquid separator 60 reaches the pressure Pb.

After the stopping step is carried out at time t2, the pressure adjustment step is carried out from time t2 until time t3. As shown in FIG. 12, in the pressure adjustment step, the control unit 138 controlsthe opening/closing valve 120 and thereby causes the first depressurization path 68 to open and controls the opening/closing valve 44 and thereby causes the oxygen gas supply path 34 to open. In this case, the hydrogen gas inside the first gas-liquid separator 54 is guided to the fuel cell stack 16 via the first depressurization path 68 and the hydrogen gas supply path 20. Furthermore, the oxygen gas inside the oxygen gas tank 124 issupplied via the oxygen gas supply path 34 to the fuel cell stack 16 andthe oxygen gas inside the second gas-liquid separator 60 is introduced into the oxygen gas tank 124 via the oxygen gas inlet path 122.

Therefore, in the pressure adjustment step, the pressure of the hydrogen gas inside the first gas-liquid separator 54 decreases more than the pressure of the oxygen gas inside the second gas-liquid separator 60. As shown in FIG. 13A, at time t3, a differential pressure ΔP4 between the pressure of the oxygen gas inside the second gas-liquid separator 60 and the pressure of the hydrogen gas inside the first gas-liquid separator 54 is generated.

At timet3, when the water recovery step is started, by means of the differential pressure ΔP4, the water that is stored inside the second gas-liquid separator 60 is returned via the water recovery path 64 to the interior of the first gas-liquid separator 54. During the generation of electrical power by the fuel cell stack 16, the water discharge step is carried out, and at time t4, the electrical power generation stopping step is performed. Thereafter, the generated water recovery step is carried out.

In accordance with the control method for the water electrolysis system 10A according to the first exemplary modification, the same effects as those of the control method for the above-described water electrolysis system 10 are provided.

### Second Exemplary Modification

Next, a description will be given concerning a water electrolysis system 10B according to a second exemplary modification. In the water electrolysis system 10B according to the second exemplary modification, the same constituent elements as those of the above-described water electrolysis systems 10 and 10A are denoted by the same reference numerals, and redundant explanations of such features will be omitted.

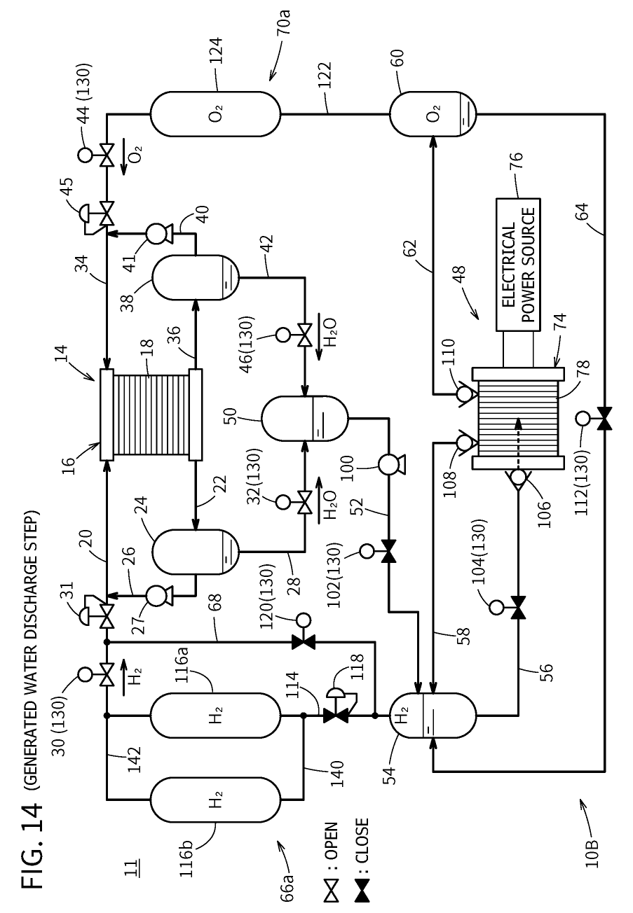

FIG. 14 is a schematic diagram of the energy system 11 equipped with the water electrolysis system 10B according to the second exemplary modification. As shown in FIG. 14, in the water electrolysis system 10B, compared to the water electrolysis system 10A according to the first exemplary modification, a hydrogen gas storage unit 66a is provided instead of the hydrogen gas storage unit 66.

The hydrogen gas storage unit 66a includes a (first) hydrogen gas tank 116a, a (second) hydrogen gas tank 116b, the hydrogen gas inlet path 114, an introduction connection path 140, and the first back pressure valve 118. Hereinafter, the hydrogen gas tank 116a will be referred to as a "first hydrogen gas tank 116a," and the hydrogen gas tank 116b will be referred to asa "second hydrogen gas tank 116b." The volume of the first hydrogen gas tank 116a is the same as the volume of the above-described hydrogen gas tank 116. The first hydrogen gas tank 116a and the second hydrogen gas tank 116b are constituted in the same manner. Stated otherwise, the volume of the second hydrogen gas tank 116b is the same as the volume of the first hydrogen gas tank 116a.

The introduction connection path 140 connects the hydrogen gas inlet path 114 and the second hydrogen gas tank 116b to each other. The first back pressure valve 118 is disposed at a portion more on an upstream side than a connection point with the introduction connection path 140 in the hydrogen gas inlet path 114. A hydrogen gas pressure threshold value of the first back pressure valve 118 is set to a pressure (the pressure Pb) that is lower than the hydrogen gas pressure threshold value of the first back pressure valve 118 in the first exemplary modification.

One end of a supply connection path 142 is connected to a second hydrogen gas tank 116b. Another end of the supply connection path 142 is connected to a portion between the first hydrogen gas tank 116a and the opening/closing valve 30 in the hydrogen gas supply path 20. More specifically, the first hydrogen gas tank 116a and the second hydrogen gas tank 116b are connected in parallel. In such a water electrolysis system 10B, the pressure of the hydrogen gas inside the first hydrogen gas tank 116a, the pressure of the hydrogen gas inside the second hydrogen gas tank 116b, and the pressure of the oxygen gas inside the oxygen gas tank 124 can be approximately equal to one another.

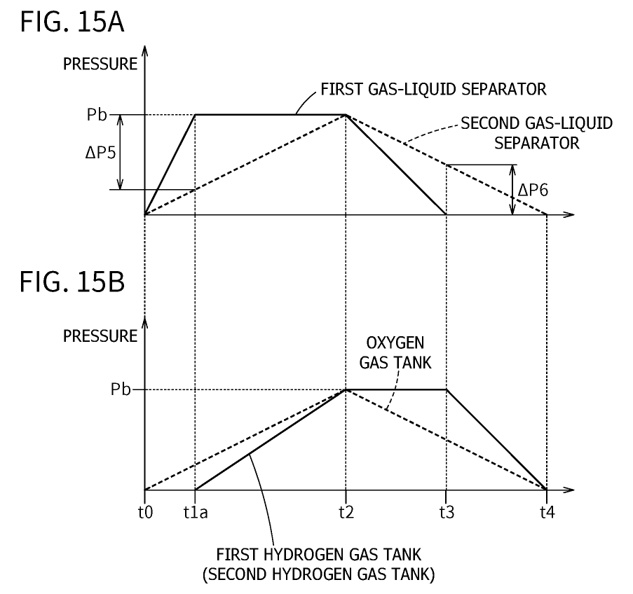

FIG. 15A is a graph showing changes in the pressure of the hydrogen gas inside the first gas-liquid separator 54 and changes in the pressure of the oxygen gas inside the second gas-liquidseparator 60 in the water electrolysis system 10B shown in FIG. 14. FIG. 15B is a graph showing changes in the pressure of the hydrogen gas pressure inside the first hydrogen gas tank 116a and the second hydrogen gas tank 116b and changes in the pressure of the oxygen gas inside the oxygen gas tank 124 in the water electrolysis system 10B shown in FIG. 14. As shown in FIGS. 15A and 15B, according to the present exemplary modification, the changes in the pressure of the oxygen gas inside the second gas-liquid separator 60 and the changes in the pressure of the oxygen gas inside the oxygen gas tank 124 are the same as those in the water electrolysis system 10A of the first exemplary modification.

According to the present exemplary modification, in the water electrolysis step (at time t1a), when the pressure of the hydrogen gas inside the first gas-liquid separator 54 reaches the hydrogen gas pressure threshold value (the pressure Pb) of the first back pressure valve 118, the hydrogen gas inside the first gas-liquid separator 54 is introduced into the first hydrogen gas tank 116a and the second hydrogen gas tank 116b. In this case, at time t1a, the pressure of the oxygen gas inside the second gas-liquid separator 60 is less than the pressure Pb. Therefore, at time t1a, a differential pressure ΔP5 between the pressure of the hydrogen gas inside the first gas-liquid separator 54 and the pressure of the oxygen gas inside the second gas-liquid separator 60 is smaller than each of the above-described differential pressure ΔP1 and the differential pressure ΔP3.

Thereafter, at time t2, the pressure of the oxygen gas inside the second gas-liquid separator 60 reaches the pressure Pb. Stated otherwise, at time t2, the pressure of the hydrogen gas inside the first gas-liquid separator 54 and the pressure of the oxygen gas inside the second gas-liquid separator 60 become the same pressure Pb. In this case, in the stopping step at time t2, the amount of permeation (gas cross-leakage) of the hydrogen gas and the oxygen gas through the electrolyte membrane 90 can be reduced.

Further, the total capacity of the first hydrogen gas tank 116a and the second hydrogen gas tank 116b is two times the capacity of the oxygen gas tank 124. Therefore, at time t2, the pressure of the hydrogen gas inside the first hydrogen gas tank 116a, the pressure of the hydrogen gas inside the second hydrogen gas tank 116b, and the pressure of the oxygen gas inside the oxygen gas tank 124 become the pressure Pb.

After the stopping step is carried out at time t2, the pressure adjustment step is carried out from time t2 until time t3. In the pressure adjustment step, in the same manner as in the water electrolysis system 10A according to the first exemplary modification, the control unit 138 controls the opening/closing valve 120 and thereby causesthe first depressurization path 68 to open and controls the opening/closing valve 44 and thereby causes the oxygen gas supply path 34 to open.

Therefore, in the pressure adjustment step, the pressure of the hydrogen gas inside the first gas-liquid separator 54 decreases more than the pressure of the oxygen gas inside the second gas-liquid separator 60. More specifically, at time t3, a differential pressure ΔP6 between the pressure of the oxygen gas inside the second gas-liquid separator 60 and the pressure of the hydrogen gas inside the first gas-liquid separator 54 is generated.

At time t3, when the water recovery step is started, by means of the differential pressure ΔP6, the water that is stored inside the second gas-liquid separator 60 is returned via the water recovery path 64 to the interior of the first gas-liquid separator 54. During the generation of electrical power by the fuel cell stack 16, the generated water discharge step is carried out. In the generated water discharge step, the hydrogen gas in the interior of the first hydrogen gas tank 116a and the hydrogen gas in the interior of the second hydrogen gas tank 116b are supplied to the fuel cell stack 16 (refer to FIG. 14). After the generated water discharge step, at time t4, the electrical power generation stopping step is carried out. Thereafter, the generated water recovery step is carried out.

In accordance with the control method for the water electrolysis system 10B according to the second exemplary modification, the same effects as those of the control method for the above-described water electrolysis system 10 are provided.

### Third Exemplary Modification

Next, a description will be given concerning a water electrolysis system 10C according to a third exemplary modification. In the water electrolysis system 10C according to the third exemplary modification, the same constituent elements as those of the above-described water electrolysis system 10, 10A, and 10B are denoted by the same reference numerals, and redundant explanations of such features will be omitted.

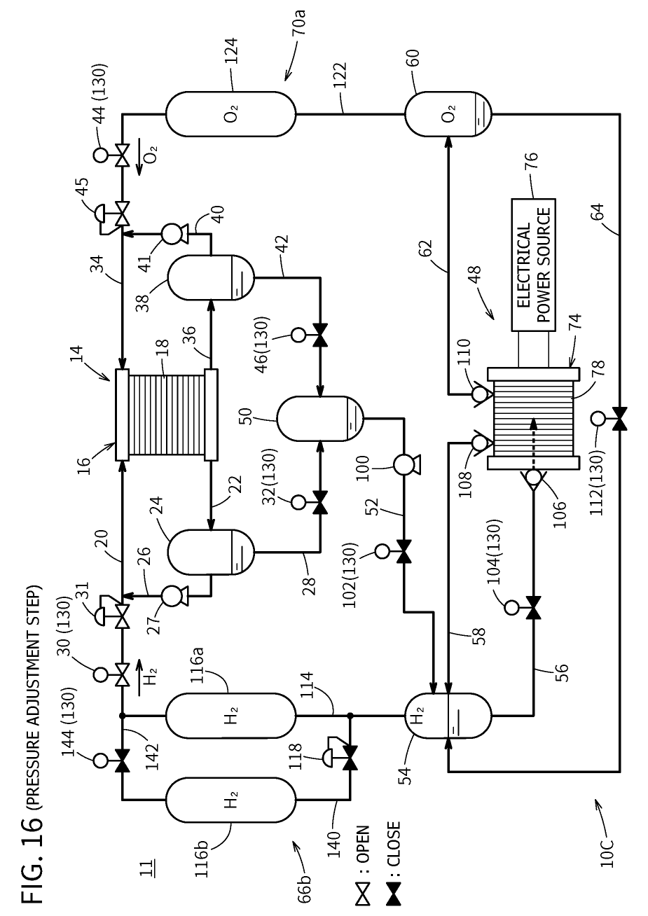

FIG. 16 is a schematic diagram of the energy system 11 equipped with the water electrolysis system 10C according to the third exemplary modification. As shown in FIG. 16, in the water electrolysis system 10C, compared to the water electrolysis system 10B according to the second exemplary modification, a hydrogen gas storage unit 66b is provided instead of the hydrogen gas storage unit 66a.

The hydrogen gas storage unit 66b includes the first hydrogen gas tank 116a, the second hydrogen gas tank 116b, the hydrogen gas inlet path 114, the introduction connection path 140, and the first back pressure valve 118. The first back pressure valve 118 is disposed in the introduction connection path 140. An opening/closing valve 144 is disposed in the supply connection path 142. The opening/closing valve 144 is a solenoid valve (the opening/closing valve 130) that opens and closes the supply connection path 142.

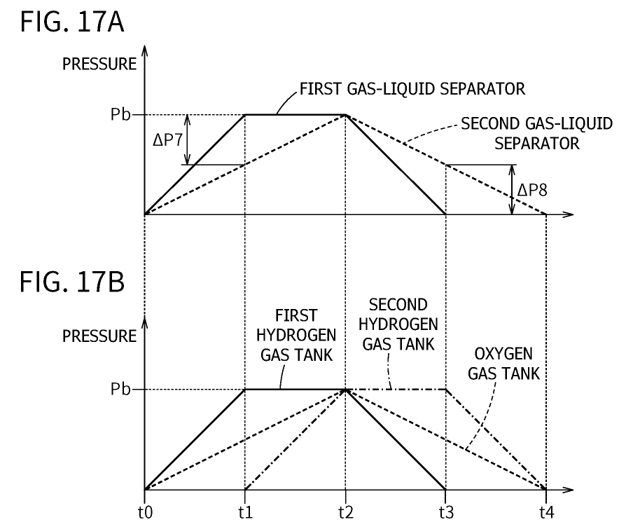

FIG. 17A is a graph showing changes in the pressure of the hydrogen gas inside the first gas-liquid separator 54 and changes in the pressure of the oxygen gas inside the second gas-liquidseparator 60 in the water electrolysis system 10C shown in FIG. 16. FIG. 17B is a graph showing changes in the pressure of the hydrogen gas inside the first hydrogen gas tank 116a and the second hydrogen gas tank 116b and changes in the pressure of the oxygen gas inside the oxygen gas tank 124 in the water electrolysis system 10C shown in FIG. 16. As shown in FIGS. 17A and 17B, according to the present exemplary modification, the changes in the pressure of the oxygen gas inside the second gas-liquid separator 60 and the changes in the pressure of the oxygen gas inside the oxygen gas tank 124 are the same as those in the water electrolysis system 10B of the second exemplary modification.

According to the present exemplary modification, the first gas-liquid separator 54 and the first hydrogen gas tank 116a are constantly in communication with each other, and therefore, when the water electrolysis step is started, the hydrogen gas generated in the water electrolysis stack 74 is introduced via the first gas-liquid separator 54 into the first hydrogen gas tank 116a. Therefore, from time t0 until time t1, the pressure of the hydrogen gas inside the first gas-liquid separator 54 and the pressure of the hydrogen gas inside the first hydrogen gas tank 116a gradually rise. According to the present exemplary modification, in the water electrolysis step (at time t1), when the pressure of the hydrogen gas inside the first gas-liquid separator 54 and the pressure of the hydrogen gas inside the first hydrogen gas tank 116a reaches the pressure Pb, the hydrogen gas inside the first gas-liquid separator 54 is introduced into the second hydrogen gas tank 116b.

In this case, at timet1, the pressure of the oxygen gas inside the second gas-liquid separator 60 is less than the pressure Pb. At time t1, a differential pressure ΔP7 between the pressure of the hydrogen gas inside the first gas-liquid separator 54 and the pressure of the oxygen gas inside the second gas-liquid separator 60 is generated.

Thereafter, at time t2, the pressure of the oxygen gas inside the second gas-liquid separator 60 reaches the pressure Pb. Stated otherwise, at time t2, the pressure of the hydrogen gas inside the first gas-liquid separator 54 and the pressure of the oxygen gas inside the second gas-liquid separator 60 become the same pressure Pb. In this case, in the stopping step at time t2, the amount of permeation (gas cross-leakage) of the hydrogen gas and the oxygen gas through the electrolyte membrane 90 can be reduced.

Further, at time t2, the pressure of the hydrogen gas inside the second hydrogen gas tank 116b becomes the pressure Pb. After the stopping step is carried out at time t2, the pressure adjustment step is carried out from time t2 until timet3. In the pressure adjustment step, the control unit 138 controlsthe opening/closing valve 30 and thereby causethe hydrogen gas supply path 20 to open and controls the opening/closing valve 44 and thereby causes the oxygen gas supply path 34 to open. The amount (the amount of substance) of the hydrogen gas consumed by the fuel cell stack 16 is two times the amount (the amount of substance) of the oxygen gas consumed by the fuel cell stack 16. Therefore, in the pressure adjustment step, the pressure of the hydrogen gas inside the first gas-liquid separator 54 decreases more than the pressure of the oxygen gas inside the second gas-liquid separator 60. More specifically, at time t3, a differential pressure ΔP8 between the pressure of the oxygen gas inside the second gas-liquid separator 60 and the pressure of the hydrogen gas inside the first gas-liquid separator 54 is generated.

At time t3, when the water recovery step is started, by means of the differential pressure ΔP8, the water that is stored inside the second gas-liquid separator 60 is returned via the water recovery path 64 to the interior of the first gas-liquid separator 54. During the generation of electrical power by the fuel cell stack 16, the generated water discharge step is carried out. In the generated water discharge step, the control unit 138 controls the opening/closing valve 144 and thereby causes the supply connection path 142 to open. Upon doing so, the hydrogen gas inside the second hydrogen gas tank 116b is supplied to the fuel cell stack 16. Therefore, the water inside the gas-liquid separator 24 can be smoothly discharged into the water tank 50. After the generated water discharge step, at time t4, the electrical power generation stopping step is carried out. Thereafter, the generated water recovery step is carried out.

In accordance with the control method for the water electrolysis system 10C according to the third exemplary modification, the same effects as those of the control method for the above-described water electrolysis system 10 are provided.

Concerning the above-described embodiment, the following supplementary notes are further disclosed.

### Supplementary Note 1

The control method for the water electrolysis system (10, 10A to 10C) comprises the water electrolysis step (S1) in which, by the water that is stored in a first gas-liquid separator (54) being supplied to the water electrolysis stack (74) via the water supply path (56) and the electrical current being supplied to the water electrolysis stack, the hydrogen gas and the oxygen gas are generated, wherein the hydrogen gas isguided to the first gas-liquid separator and the oxygen gas is guided to the second gas-liquid separator (60), the stopping step (S2) of causing the water electrolysis of the water electrolysis stack to stop, after the stopping step, the pressure adjustment step (S3) that is capable of setting the pressure of the hydrogen gas inside the first gas-liquid separator to a pressure that is lower than the pressure of the oxygen gas inside the second gas-liquid separator, and after the pressure adjustment step, the water recovery step (S4) in which, using the differential pressure (ΔP2, ΔP4, ΔP6, ΔP8) between the pressure of the hydrogen gas inside the first gas-liquid separator and the pressure of the oxygen gas inside the secondgas-liquid separator, the water that is stored in the second gas-liquid separator is returned via the water recovery path (64) to the first gas-liquid separator.

In accordance with such a configuration, due to the differential pressure between the pressure of the hydrogen gas inside the first gas-liquid separator and the pressure of the oxygen gas inside the second gas-liquid separator, the water that is stored in the second gas-liquid separator can be returned to the first gas-liquid separator. In accordance therewith, there is no necessity to provide a pump in the water recovery path in order to return the water that is stored inside the second gas-liquid separator to the first gas-liquid separator. Accordingly, a decrease in energy efficiency can be suppressed. Thus, it is possible to obtain a more satisfactory control method for the water electrolysis system.

### Supplementary Note 2

In the control method for the water electrolysis system according to Supplementary Note 1, the volume of the first gas-liquid separator may be equal to the volume of the second gas-liquid separator, and in the pressure adjustment step, by the hydrogen gas being discharged from the first gas-liquid separator, the pressure of the hydrogen gas inside the first gas-liquid separator may be set to a pressure that is lower than the pressure of the oxygen gas inside the second gas-liquid separator.

In accordance with such a configuration, in the pressure adjustment step, with a simple method, the pressure of the hydrogen gas inside the first gas-liquid separator can be made lower than the pressure of the oxygen gas inside the second gas-liquid separator.

### Supplementary Note 3

In the control method for the water electrolysis system according to Supplementary Note 2, in the pressure adjustment step, the fuel cell stack may be made to generate electrical power, by guiding the hydrogen gas inside the first gas-liquid separator and the oxygen gas inside the second gas-liquid separator to the fuel cell stack (16).

In accordance with such a configuration, since the electrical power can be generated using the hydrogen gas inside the first gas-liquid separator and the oxygen gas inside the oxygen gas tank and the second gas-liquid separator, the energy can be effectively utilized.

### Supplementary Note 4

In the control method for the water electrolysis system according to Supplementary Note 3, in the water electrolysis step, the hydrogen gas that is guided from the water electrolysis stack to the first gas-liquid separator may be stored under pressure in the hydrogen gas tank (116, 116a, 116b) and the oxygen gas that is guided from the water electrolysis stack to the second gas-liquid separator may be stored under pressure in the oxygen gas tank (124).

In accordance with such a configuration, the fuel cell stack is capable of stably generating electrical power by using the hydrogen gas that is stored under pressure in the hydrogen gas tank and the oxygen gas that is stored under pressure in the oxygen gas tank.

### Supplementary Note 5

In the control method for the water electrolysis system according to Supplementary Note 4, in the pressure adjustment step, in a state in which supplying the hydrogen gas from the hydrogen gas tank to the fuel cell stack has been stopped, the hydrogen gas may be supplied to the fuel cell stack from the first gas-liquid separator, and further, the oxygen gas may be supplied to the fuel cell stack from both the oxygen gas tank and the second gas-liquid separator.

In accordance with such a configuration, in the pressure adjustment step, with a simple method, the pressure of the hydrogen gas inside the first gas-liquid separator can be made lower than the pressure of the oxygen gas inside the second gas-liquid separator.

### Supplementary Note 6

In the control method for the water electrolysis system according to any one of Supplementary Notes 1 to 5, in the water electrolysis step, the water that is stored inside the first gas-liquid separator may be guided by gravity via the water supply path to the water electrolysis stack.

In accordance with such a configuration, since it is unnecessary to provide a pump in order to guide the water that is stored in the first gas-liquid separator to the water electrolysis stack, the number of component parts in the water electrolysis system can be reduced. Further, since electrical power for the purpose of driving the pump is unnecessary, it is possible to suppress a decrease in the energy efficiency of the water electrolysis system.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical expressions are used in the description of the aforementioned embodiments.

1. A control method for a water electrolysis system, comprising:
electrolyzing waterbysupplying water that is stored in a first gas-liquid separator to a water electrolysis stack via a water supply path and supplying an electrical current to the water electrolysis stack to generate a hydrogen gas and an oxygen gas, wherein the hydrogen gas isguided to the first gas-liquid separator and the oxygen gas is guided to a second gas-liquid separator;
stopping water electrolysis of the water electrolysis stack;
after the stopping of the water electrolysis, adjusting a pressure of the hydrogen gas inside the first gas-liquid separator to a pressure that is allowed to be lower than a pressure of the oxygen gas inside the second gas-liquid separator; and
after the adjustingof the pressure, returning, using a differential pressure between the pressure of the hydrogen gas inside the first gas-liquid separator and the pressure of the oxygen gas inside the secondgas-liquid separator, water that is stored inside the second gas-liquid separator is returned via a water recovery path to the first gas-liquid separator.

2. The control method for the water electrolysis system according to claim 1, wherein:
avolume of the first gas-liquid separator is equal to avolume of the second gas-liquid separator; and
in the adjustingof thepressure, by the hydrogen gas being discharged from the first gas-liquid separator, the pressure of the hydrogen gas inside the first gas-liquid separator is set to a pressure that is lower than the pressure of the oxygen gas inside the second gas-liquid separator.

3. The control method for the water electrolysis system according to claim 2, wherein, in the adjustingof thepressure, by guiding, to a fuel cell stack, the hydrogen gas inside the first gas-liquid separator and the oxygen gas inside the second gas-liquid separator, the fuel cell stack is made to generate electrical power.

4. The control method for the water electrolysis system according to claim 3, wherein, in the electrolyzing of water, the hydrogen gas that is guided from the water electrolysis stack to the first gas-liquid separator isstored under pressure in ahydrogen gas tank and the oxygen gas that is guided from the water electrolysis stack to the second gas-liquid separator is stored under pressure in anoxygen gas tank.

5. The control method for the water electrolysis system according to claim 4, whereinin the adjustingof thepressure, in a state in which supplyingof the hydrogen gas from the hydrogen gas tank to the fuel cell stack has been stopped, the hydrogen gas is supplied to the fuel cell stack from the first gas-liquid separator, and further, the oxygen gas is supplied to the fuel cell stack from both the oxygen gas tank and the second gas-liquid separator.

6. The control method for the water electrolysis system according to claim 1, wherein, in the electrolyzing of water, the water that is stored inside the first gas-liquid separator is guided by gravity via the water supply path to the water electrolysis stack.
